(19) United States
(12) Patent Application Publication
(10) Pub. No.: US 2017/0144482 A1
(43) Pub. Date: May 25, 2017

(54) Wheel Bearing Apparatus

(71) Applicant: NTN Corporation, Osaka-shi (JP)

(72) Inventors: Kazuhisa SHIGEOKA, Iwata-shi (JP); Hiroto SUMA, Iwata-shi (JP); Kentarou NISHIKAWA, Iwata-shi (JP); Makoto SEKI, Bizen-shi (JP)

(21) Appl. No.: 15/424,796

(22) Filed: Feb. 4, 2017

Related U.S. Application Data
(63) Continuation of application No. PCT/JP2015/072251, filed on Aug. 5, 2015.

(30) Foreign Application Priority Data
Aug. 6, 2014 (JP) 2014-160189

(51) Int. Cl. B60B 35/18; F16C 19/52; F16F 15/02; F16C 19/18

(52) U.S. Cl. CPC B60B 35/18; F16C 19/186; F16C 19/527; F16F 15/02; F16C 2326/02

(57) ABSTRACT

A wheel bearing apparatus has an outer member, an inner member and double row rolling elements contained between outer raceway surfaces and inner raceway surfaces, respectively, of the outer member and the inner member. A vibration damping mechanism is mounted on a portion of the outer member or the inner member except at portions engaging with mating components.

### CROSS-REFERENCE TO RELATED APPLICATIONS

This application is a continuation of International Application No. PCT/JP2015/072251, filed Aug. 5, 2015, which claims priority to Japanese Application No. 2014-160189, filed Aug. 6, 2014. The disclosures of the above applications are incorporating herein by reference.

### FIELD

The present disclosure generally relates to a wheel bearing apparatus that rotationally supports a wheel of a vehicle, such as an automobile and, more particularly, to a wheel bearing apparatus that includes a vibration damping mechanism in a vibration transmitting route.

### BACKGROUND

A structure where an anti-vibration mechanism is on a wheel bearing apparatus for mounting a tire and wheel or a brake disc has been proposed. Structures exist where a cylindrical vibration damping material is on a portion of the wheel bearing apparatus between a wheel hub for mounting a wheel and a wheel hub. For example as shown in FIG. 7, a vibration damping mechanism with a vibration suppressing member 55, formed of elastic material, is interposed between inner rings 51, 52 and outer joint member 54 of a constant speed universal joint 53 of a double row rolling bearing 50. The vibration suppressing member 55 suppresses transmission of vibration to the double row rolling bearing 50 by damping the vibration of the constant speed universal joint 53. Thus, this improves the bearing life by suppressing fretting wear of the bearing caused by the vibration (e.g., see JP2001-246903 A). The vibration suppressing member 55 includes polymer material such as thermoplastic resin or elastomer or vibration suppressing steel sheet sandwiching the polymer material.

However, although the vibration suppressing material, such as polymer material applied to a wheel hub of an automobile, has superior vibration absorbing effect in a high frequency region higher than several kHz, sufficient damping effect cannot be obtained by the polymer material, such as rubber, against resonance noise of 200˜300 Hz caused by vibration of rubber tires due to irregularities in the road. In addition, when the application of an eccentric load is repeated or continued against a wheel hub for a long time, it caused problems in the durability of the wheel hub and promotion of compressive permanent distortion caused by the eccentric load.

A wheel bearing apparatus 56 shown in FIG. 8 can solve these problems. The wheel bearing apparatus 56 includes a hub 60 with a cylindrical hub body 58 to be mounted on a tip end of an axle 57. A wheel mounting portion (wheel mounting flange) 59 radially extends from the hub body 58. A bearing portion 61 is mounted on an outer circumference of the hub body 58.

The bearing portion 61 has inner rings 62 mounted on the hub 60. The inner rings 62 are rotational together with the axle 57 and the hub 60. An outer ring 63 is arranged radially outward of the inner rings 62. A plurality of balls 64 is arranged between the inner rings 62 and the outer ring 63. The outer ring 63 is not-rotationally assembled to a knuckle 65 of a suspension of the automobile.

A vibration absorbing portion 67 is mounted on a vibration transmitting route from the axle 57 to the knuckle 65. The vibration absorbing portion 67 is formed of vibration suppressing alloy material to dampen vibration based on the internal friction damping mechanism particular to the alloy material. The vibration absorbing portion 67 is formed of a material different from a polymer material such as rubber or elastomer. The vibration absorbing portion 67 has remarkable vibration absorbing effect and also has an effect relative to noise or vibration lower than 1 kHz. Thus, it is able to effectively dampen the resonance noise that mainly causes cabin noise and vibration. Accordingly, it is possible to effectively prevent the noise or discomfort derived from the vibration leaking into the cabin of an automobile. In addition, the vibration absorbing portion 67, formed of vibration suppressing alloy material, has strength higher than the vibration absorbing portion formed from polymer material. It also has superior durability. Furthermore, the vibration absorbing portion 67 is less likely to accumulate the compressive permanent distortion particular in the polymer material even though eccentric loads are repeatedly applied (e.g. see JP2006-306382 A).

However, although the wheel bearing apparatus 56 of the prior art can dampen vibration, it cannot prevent the resonance vibration between the constant velocity universal joint 53 and the bearing portion 61. Accordingly, it is believed that unpleasant noise would be caused in the cabin of the automobile. Also in the prior art, the bearing pre-load is applied to the double row rolling bearing 50 or the wheel bearing apparatus 56. Additionally, the elastic member 55 or the vibration absorbing portion 67 is arranged between the bearing 50 and the constant velocity universal joint 53 or between the bearing and knuckle 65. Accordingly, the rigidity of suspension is lowered.

### SUMMARY

It is, therefore, an object of the present disclosure to provide a wheel bearing apparatus that can solve the problems of the above described prior art. The wheel bearing apparatus prevents the generation of resonance vibration between the bearing portion and its peripheral components while keeping the rigidity of the bearing. The wheel bearing apparatus has superiorities in both vibration absorbing performance and durability.

To achieve the objects of the disclosure, a wheel bearing apparatus comprises an outer member, inner member, double row rolling elements and a vibration damping mechanism. The outer member inner circumference has double row outer raceway surfaces. The outer member outer circumference is adapted to be mounted on a knuckle of a vehicle. The inner member includes a wheel hub and at least one inner ring. The wheel hub is integrally formed, on its one end, with a wheel mounting flange. A cylindrical portion axially extends from the wheel mounting flange. The inner ring is press fit onto the cylindrical portion of the wheel hub. The inner member outer circumferences has double row inner raceway surfaces opposing the double row outer raceway surfaces. The double row rolling elements are contained between the outer raceway surfaces and inner raceway surfaces, respectively, of the outer member and the inner member. A vibration damping mechanism is mounted on a portion of the outer member or the inner member except at portions engaging with their mating components. The vibration damping mechanism prevents resonance vibration between the bearing and its peripheral components.

The outer member inner circumference has double row outer raceway surfaces. The outer member outer circumference is adapted to be mounted on a knuckle of a vehicle. The inner member includes a wheel hub and at least one inner ring. The wheel hub is integrally formed, on its one end, with a wheel mounting flange. A cylindrical portion axially extends from the wheel mounting flange. The inner ring is press fit onto the cylindrical portion of the wheel hub. The inner member outer circumferences has double row inner raceway surfaces opposing the double row outer raceway surfaces. Double row rolling elements are contained between the outer raceway surfaces and inner raceway surfaces, respectively, of the outer member and the inner member. A vibration damping mechanism is mounted on a portion of the outer member or the inner member except at portions engaging with their mating components. The vibration damping mechanism prevents resonance vibration between a bearing and its peripheral components. Thus, it is possible to remarkably reduce abnormal noise in the cabin of an automobile even though noise of the driving source, such as an electric car, is reduced. The noise reduction occurs by preventing the generation of the resonance vibration between the bearing portion and its peripheral components while changing the natural frequency of the bearing portion while considering the resonance point between the bearing portion and its peripheral components.

The vibration damping mechanism includes a metallic weight and an elastic member covering the outer surfaces of the metallic weight. Mounting portions are formed on both ends of the elastic member. Annular grooves are formed on the outer circumferences of the mounting portions. The vibration damping mechanism is adapted to be secured on the inner member or the outer member by metallic fastening bands mounted in the annular grooves.

The vibration damping member has a metal core insert molded into engaging surfaces of an elastic member. The vibration damping member is adapted to be press-fit on the inner member or outer member via the metal core.

The vibration damping mechanism is secured on the axially center portion between the double row inner raceway surfaces. This makes it possible, especially in a wheel bearing apparatus with a large axial pitch distance of the double row rolling elements, to reduce the amount of grease confined in the bearing. Also, it improves the lubrication efficiency while suppressing the stay of grease in the middle of the bearing.

The inner ring is formed with a cylindrical securing portion that extends from the inner raceway surface toward the inner-side, via a seal-fitting portion. The vibration damping mechanism is secured on the outer circumference of the securing portion. Thus, it is possible to simplify the assembling work of the vibration damping mechanism. This enables easy adjustment and exchange of the vibration damping mechanism.

The outer member is formed on its outer-side end with a cylindrical securing portion. The vibration damping mechanism is secured on the securing portion. Thus, it is unnecessary to strongly increase the fastening force taking bulging of the vibration damping mechanism, by the centrifugal force, into consideration. This makes it easy to adjust and exchange the vibration damping mechanism.

The vibration damping mechanism is secured on the inner circumference of the outer member between the outer raceway surfaces. Thus, is unnecessary to strongly increase the securing force taking bulging of the vibration damping mechanism, by the centrifugal force, into consideration. This simplifies the assembling work of the vibration damping mechanism and reduces the amount of grease confined in the bearing. This improves the lubrication efficiency while preventing the stay of grease in the middle of the bearing.

According to the wheel bearing apparatus of the present disclosure, it comprises an outer member, an inner member, double row rolling elements and a vibration damping mechanism. The outer member inner circumference has double row outer raceway surfaces. The outer member outer circumference is adapted to be mounted on a knuckle of a vehicle. The inner member includes a wheel hub and at least one inner ring. The wheel hub is integrally formed, on its one end, with a wheel mounting flange. A cylindrical portion axially extends from the wheel mounting flange. The inner ring is press fit onto the cylindrical portion of the wheel hub. The inner member outer circumferences has double row inner raceway surfaces that oppose the double row outer raceway surfaces. The double row rolling elements are contained between the outer raceway surfaces and inner raceway surfaces, respectively, of the outer member and the inner member. The vibration damping mechanism, to prevent resonance vibration between the bearing and its peripheral components, is mounted on a portion of the outer member or the inner member except at portions that engage their mating components. Thus, it is possible to remarkably reduce abnormal noise in the cabin of an automobile even though noise of the driving source, such as an electric car, is reduced. The vibration damping mechanism prevents the generation of the resonance vibration between the bearing portion and its peripheral components while changing the natural frequency of the bearing portion considering the resonance point between the bearing portion and its peripheral components.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a longitudinal-sectional view of one embodiment of a wheel bearing apparatus of the present disclosure.

FIG. 2 is an enlarged view of a vibration damping mechanism of FIG. 1.

FIG. 3 is an enlarged view of a modification of the vibration damping mechanism of FIG. 2.

FIG. 4 is a longitudinal-sectional view of a modification of the wheel bearing apparatus of FIG. 1.

FIG. 5 is a longitudinal-sectional view of another modification of the wheel bearing apparatus of FIG. 1.

FIG. 6 is a longitudinal-sectional view of a further modification of the wheel bearing apparatus of FIG. 1.

FIG. 7 is a longitudinal-sectional view of a prior art wheel bearing apparatus.

FIG. 8 is a longitudinal-sectional view of another prior art wheel bearing apparatus.

### DETAILED DESCRIPTION

Hereafter, embodiments of the present disclosure will be specifically described with reference to the attached drawings.

A wheel bearing apparatus comprises an outer member, inner member, double row of rolling elements and a vibration damping mechanism. The outer member outer circumference has an integrally formed body mounting flange. The flange is to be mounted on a knuckle. The outer member inner circumference has double row outer raceway surfaces. The inner member includes a wheel hub and an inner ring. The wheel hub is integrally formed, on its one end, with a wheel mounting flange. A cylindrical portion axially extends from the wheel mounting flange. The inner ring is press-fit onto the cylindrical portion of the wheel hub. The wheel hub and the inner ring outer circumferences, respectively, have double row inner raceway surfaces that oppose the double row outer raceway surfaces. The double row rolling elements are contained between the inner and outer raceway surfaces, respectively, of the inner and outer members. Seals are mounted in annular openings formed between both ends of the outer and inner members. The vibration damping mechanism is secured on the axially center portion between the double row inner raceway surfaces. The vibration damping mechanism comprises a metallic weight and an elastic member. The elastic member has a predetermined thickness and covers the outer surfaces of the metallic weight. Mounting portions are formed on both ends of the elastic member. Annular grooves are formed on the outer circumferences of the mounting portions. The vibration damping mechanism is adapted to be secured on the inner member or the outer member by metallic fastening bands mounted in the annular grooves.

A preferred embodiment of the present disclosure will be described with reference to the accompanied drawings.

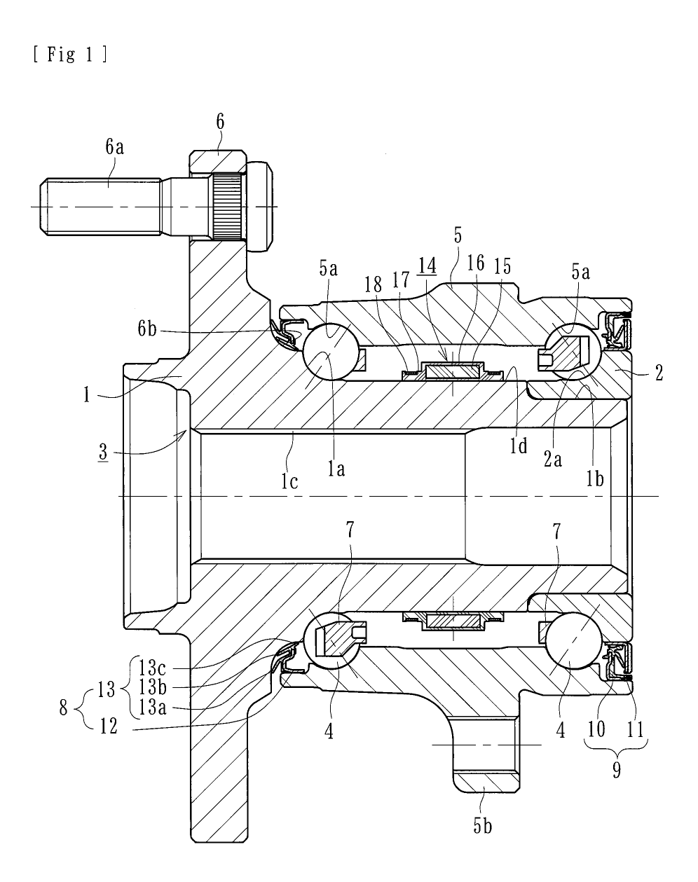

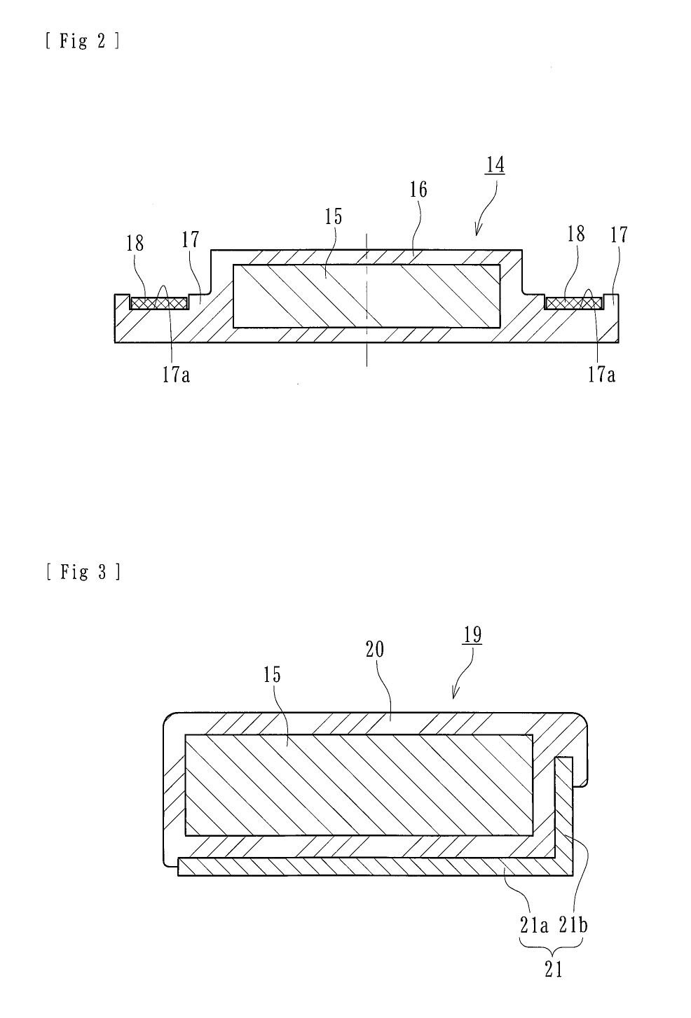

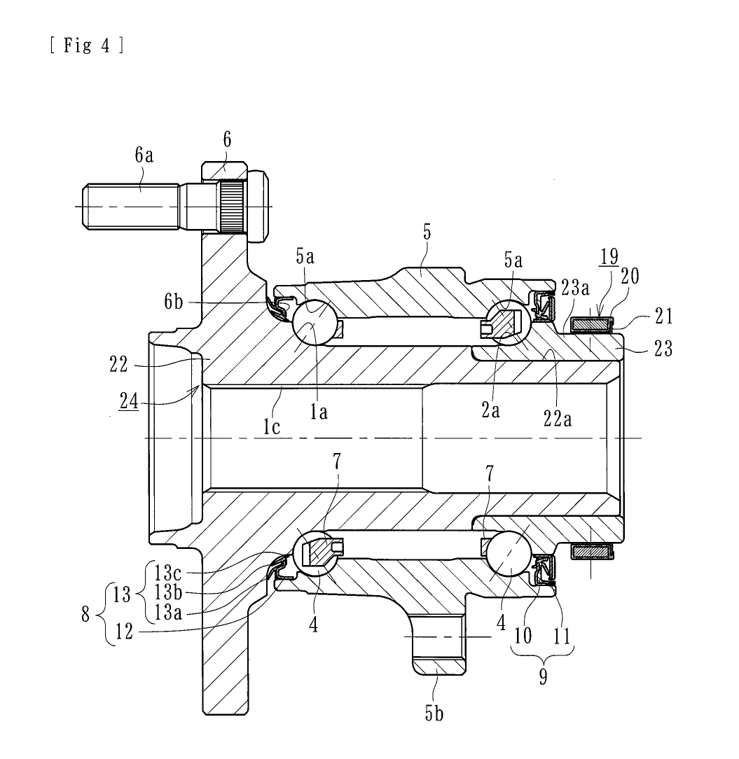

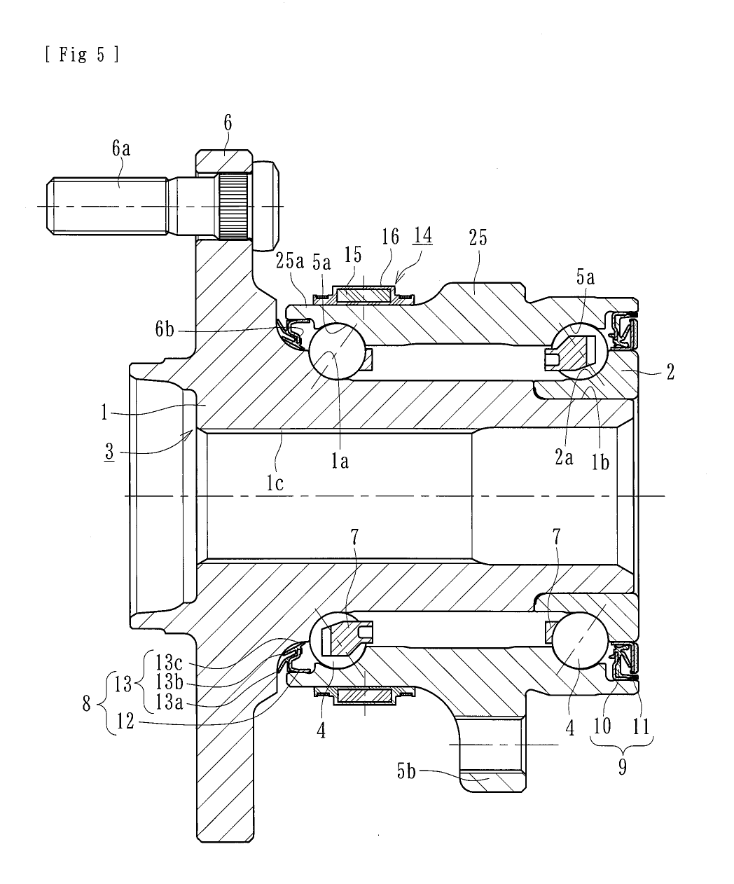

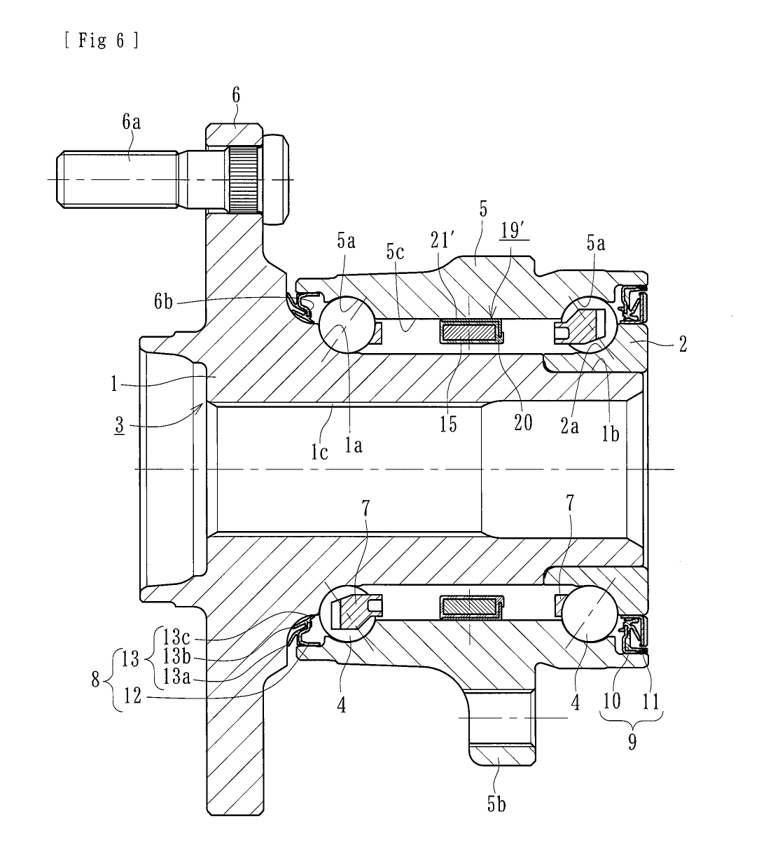

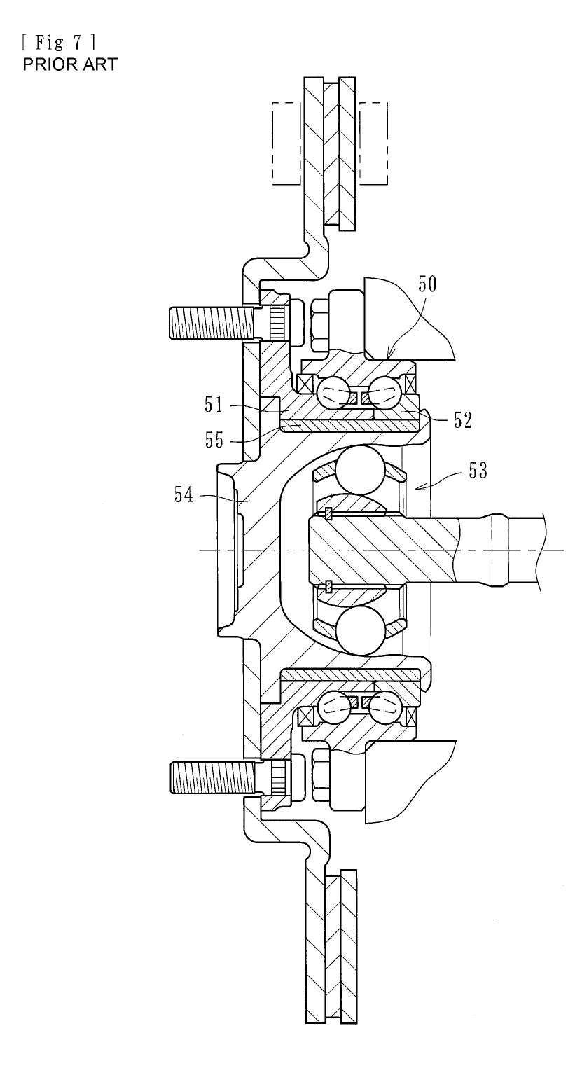

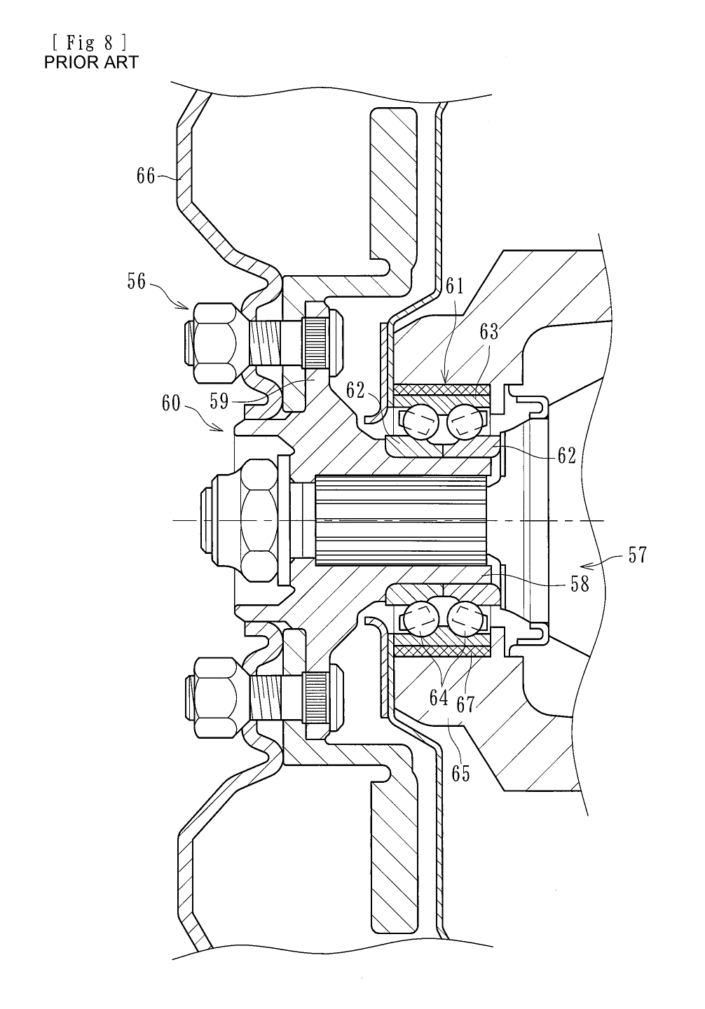

FIG. 1 is a longitudinal-sectional view of one embodiment of a wheel bearing apparatus. FIG. 2 is an enlarged view of a vibration damping mechanism of FIG. 1. FIG. 3 is an enlarged view of a modification of the vibration damping mechanism of FIG. 2. FIG. 4 is a longitudinal-sectional view of a modification of the wheel bearing apparatus of FIG. 1. FIG. 5 is a longitudinal-sectional view of another modification of the wheel bearing apparatus of FIG. 1. FIG. 6 is a longitudinal-sectional view of a further modification of the wheel bearing apparatus of FIG. 1. In the description of the specification, an outer-side of a bearing apparatus, when it is mounted on a vehicle, is referred to as “outer-side” (a left-side in a drawing). An inner-side of a bearing apparatus, when it is mounted on a vehicle, is referred to as “inner-side” (a right-side in a drawing).

The wheel bearing apparatus shown in FIG. 1 is a so-called “third generation” type for a driving wheel. It includes an inner member 3 with a wheel hub 1 and an inner ring 2 press-fit onto the wheel hub 1. An outer member 5 is mounted on the inner member 3, via a double row rolling elements (balls) 4, 4.

The wheel hub 1 is integrally formed, on its outer-side end, with a wheel mount flange 6 to mount a wheel (not shown). The wheel hub outer circumference is formed with one (outer-side) inner raceway surface 1a. A cylindrical portion 1b axially extends from the inner raceway surface 1a. A serration (or spline) 1c, for torque transmission, is formed on the inner circumference of the wheel hub 1. Hub bolts 6a are secured on the wheel mounting flange 6 at circumferentially equidistant positions. The inner ring 2 outer circumference includes an inner raceway surface 2a. The inner ring 2 is press-fit, via a predetermined interference, onto the outer circumference of the cylindrical portion 1b of the wheel hub 1.

The wheel hub 1 is made from medium-high carbon steel such as S53C including carbon of 0.40˜0.80% by weight. It is hardened by high frequency induction hardening to have a surface hardness of 58˜64 HRC over the inner raceway surface 1a and a region from an inner-side base 6b of the wheel mounting flange 6 to the cylindrical portion 1b. The inner ring 2 is formed from high carbon chrome steel such as SUJ2. It is dip hardened to its core to have a hardness of 58˜64 HRC. The rolling elements (balls) 4 are formed from high carbon chrome steel, such as SUJ2, and are dip hardened to have a hardness of 62˜67 HRC.

The outer member 5 outer circumference has a body mount flange 5b. The flange 5b is adapted to be mounted on a knuckle (not shown), which forms part of the suspension. The outer member inner circumference has double row outer raceway surfaces 5a, 5a that oppose the inner raceway surfaces 1a, 2a of the inner member 3. The double row rolling elements 4, 4 are rollably contained between the inner and outer raceway surfaces 5a, 1a and 5a, 2a, via cages 7.

The outer member 5 is formed of medium-high carbon steel such as S53C including carbon of 0.40˜0.80% by weight. At least the outer raceway surfaces 5a, 5a are hardened by high frequency induction hardening to have a surface hardness of 58˜64 HRC. Seals 8, 9 are mounted on both end openings formed between the outer member 5 and inner member 3. The seals 8, 9 prevent leakage of lubricating grease confined within the bearing and entry of rain water or dust from the outside into the bearing.

The inner-side seal 9 of seals 8, 9 is formed as a so-called a pack seal. It comprises an annular sealing plate 10 and a slinger 11 oppositely arranged to each other. The sealing plate 10 is press-fit into the inner-side end of the outer member 5, to form a stator member, via a predetermined interference. The slinger 11 is press-fit onto the inner ring 2, to form a rotational member, via a predetermined interference.

The outer-side seal 8 is formed as an integrated seal. It comprises a metal core 12 press-fit into the outer-side end of the outer member 5. A sealing member 13 is adhered to the metal core 12. The metal core 12 is press-formed from austenitic stainless steel sheet (JIS SUS 304 etc.) or preserved cold rolled steel sheet (JIS SPCC etc.) so as to have a generally annular configuration.

The sealing member 13 is formed of synthetic rubber such as NBR (acrylonitrile-butadiene rubber). It is integrally adhered to the metal core 12 by vulcanizing adhesion. The sealing member 13 comprises an integrally formed side lip 13a, dust lip 13b and grease lip 13c. The side lip 13a is inclined radially outward. The dust lip 13b is inclined radially outward radially inward of the side lip 13a. The grease lip 13c is inclined toward the inner-side.

The inner-side base portion 6b of the wheel mounting flange 6 is formed with a circular arc cross-section. The side lip 13a and the dust lip 13b slidably contact the base portion 6b, via a predetermined axial interference. The grease lip 13c also slidably contacts the base portion 6b, via a predetermined radial interference. There are examples of material of sealing member 13 other than NBR such as HNBR (hydrogenation acrylonitric-butadiene rubber), EPDM (ethylene propylene rubber), ACM (poly-acrylic rubber) superior in heat and chemical resistance, FKM (fluororubber) or silicone rubber.

Although the wheel bearing apparatus is shown formed with a double row angular contact ball bearing using balls as rolling elements 4, the present disclosure is not limited to such a bearing. A double row tapered roller bearing, using tapered rollers as rolling elements 4, may be used. In addition, the bearing is shown as a third generation type where the inner raceway surface 2a is directly formed on the outer circumference of the wheel hub 1. The present disclosure can be applied to the first and second generation type bearings (not shown) where a pair of inner rings is press-fit onto the cylindrical portion 1b.

As shown in FIG. 1, a vibration damping mechanism 14 (i.e. resonance vibration preventing apparatus) is secured on the axially center portion of the wheel hub between the double row inner raceway surfaces 1a, 2a. More particularly, it is positioned on the outer circumference 1d from the inner raceway surface 1a of the wheel hub 1 to the cylindrical portion 1b.

As shown in the enlarged view of FIG. 2, the vibration damping mechanism 14 comprises an annular metallic weight 15 and elastic member 16. The weight 15 is formed from iron based metal. The elastic member 16 is formed from synthetic rubber, such as NBR. The elastic member 16 has a predetermined thickness to cover the outer surfaces of the metallic weight 15. Mounting portions 17, 17 are formed on both ends of the elastic member 16. Annular grooves 17a, 17a are formed on the outer circumferences of the mounting portions 17, 17. The vibration damping mechanism 14 is adapted to be secured on the outer circumference 1d of the wheel hub 1 by metallic fastening bands 18, 18 mounted in the annular grooves 17a, 17a.

It is possible to dampen vibrations on a vibration transmitting route transmitted via the bearing portion by the elastic member 16 of the vibration damping mechanism 14. In addition, it is possible to prevent the generation of resonance vibration between the bearing portion and its peripheral components by changing the natural frequency of the bearing portion taking the resonance point between the bearing portion and its peripheral components into consideration. Thus, it is possible to provide a wheel bearing apparatus that has superiorities in both vibration absorbing performance and durability.

In this kind of wheel bearing apparatus, with a large axial pitch distance of the double row rolling elements 4, 4, it is believed that not only will manufacturing costs increase due to an increase of lubrication grease to be filled within the bearing but an increase in temperature of the bearing will occur due to agitating resistance of the grease. Also, a lowering of lubrication efficiency will occur due to the stay of grease, actually contributing to the bearing lubrication, in an axially middle portion of the double row inner raceway surfaces 1a, 2a. However, according to the present disclosure, it is possible to reduce the grease filling amount and suppress the stay of grease in the middle portion of bearing. This improves the lubrication efficiency by mounting the vibration damping mechanism 14 in the axially middle portion between the double row inner raceway surfaces 1a, 2a.

Although it is described as using an iron based annular metal as the weight 15, it may be possible to use other metals with high specific weight. Some examples are nonferrous metal such as zinc, copper, lead, nickel etc. A plurality of weights may be circumferentially arranged in place of the annular configuration. The elastic member 16 may be formed from thermoplastic resin such as PA (polyamide) 66 other than synthetic rubber.

FIG. 3 shows a modification of the vibration damping mechanism 14 shown in FIG. 2. The same reference numerals are used to designate the same structural elements of the previously described embodiment. Thus, their detailed description will be omitted.

The vibration damping mechanism 19 of FIG. 3 comprises an annular weight 15 and elastic member 20. The weight 15 is an iron based metal. The elastic member 20 is a synthetic rubber such as NBR etc. The elastic member 20 has a predetermined thickness to cover the outer surface of the weight 15. A metal core 21 is insert molded integrally with the elastic member 20 at its engaging surfaces. The metal core 21 is adapted to be press-fit onto the outer circumference 1d of the wheel hub 1.

The metal core 21 is formed of ferritic stainless steel sheet, austenitic stainless steel sheet or preserved cold rolled steel sheet by press working to have an L-shaped cross-section. The metal core 21 has a cylindrical fitting portion 21a and a standing portion 21b. The fitting portion 21a is adapted to be press-fit onto the outer circumference 1d of the wheel hub 1. The standing portion 21b extends radially inward from the end of the fitting portion 21a. Such a configuration of the metal core 21 enables it to have sufficient strength and rigidity even though it uses a thin material. Thus, this improves the workability during press-fitting and the securing power after press-fitting.

In addition to the advantages of the vibration damping mechanism 14 of FIG. 2, the vibration damping mechanism 19 of this modification of FIG. 3 can be easily mounted onto the outer circumference 1d of the wheel hub 1 only by press-fitting. Thus, this can simplify the assembling workability. Furthermore, the vibration damping mechanism 19 makes it possible to dampen vibrations on the vibration transmitting route via the bearing by the elastic member 20 of the vibration damping mechanism 19. Also, it is possible to prevent the generation of resonance vibration between the bearing portion and its peripheral components by the weight 15 of the vibration damping mechanism 19 changing the natural frequency of the bearing portion previously taking the resonance point between the bearing portion and its peripheral components into consideration.

A wheel bearing apparatus shown in FIG. 4 is a modification of the previous embodiment (FIG. 1). This modification is different from the embodiment of FIG. 1 only in the structures of the inner member and the vibration damping mechanism. Accordingly, the same reference numerals are used to designate the same structural elements of the previously described embodiment. Thus, their detailed description will be omitted.

The wheel bearing apparatus shown in FIG. 4 is a so-called “third generation” type for a driving wheel. It comprises an inner member 24 with a wheel hub 22 and an inner ring 23 press-fit onto the wheel hub 22. An outer member 5 is mounted on the inner member 24 via the double row rolling elements 4, 4.

The wheel hub 22 is integrally formed, on its outer-side end, with a wheel mount flange 6 to mount a wheel (not shown). The inner member outer circumference has one (outer-side) inner raceway surface 1a. A cylindrical portion 22a axially extends from the inner raceway surface 1a. A serration (or spline) 1c, for torque transmission, is formed on the inner circumference of the wheel hub 22. The inner ring 23 outer circumference has the other (inner-side) inner raceway surface 2a. A cylindrical securing portion 23a extends from the inner raceway surface 2a toward the inner-side via a seal-fitting portion of the seal 9. The inner ring 23 is press-fit, via a predetermined interference, onto the outer circumference of the cylindrical portion 22a of the wheel hub 22.

The wheel hub 22 is made of medium-high carbon steel such as S53C including carbon of 0.40˜0.80% by weight. It is hardened by high frequency induction hardening to have a surface hardness of 58˜64 HRC over the inner raceway surface 1a and a region from the inner-side base 6b of the wheel mounting flange 6 to the cylindrical portion 22a. The inner ring 23 is formed of high carbon chrome steel such as SUJ2. It is dip hardened to its core to have a hardness of 58˜64 HRC.

The vibration damping mechanism 19 is secured on the inner-side end of the inner member 24. More particularly, on the outer circumference of the securing portion 23a. It is possible to simplify the assembling work of the vibration damping mechanism 19. This enables easy adjustment and exchange of the vibration damping mechanism 19.

A wheel bearing apparatus shown in FIG. 5 is another modification of the previous embodiment (FIG. 1). This modification is different from the embodiment of FIG. 1 only in a configuration of the outer member. Accordingly, the same reference numerals are used to designate the same structural elements of the previously described embodiments. Thus, their detailed description will be omitted.

The wheel bearing apparatus shown in FIG. 5 is a so-called “third generation” type for a driving wheel. It comprises an inner member 3 with a wheel hub 1 and an inner ring 2 press-fit on the wheel hub 1. An outer member 25 is mounted on the inner member 3 via the double row rolling elements 4, 4.

The outer member 25 outer circumference has a body mount flange 5b adapted to be mounted on a knuckle (not shown). The knuckle forms part of the suspension. The outer member inner circumference has double row outer raceway surfaces 5a, 5a that oppose the inner raceway surfaces 1a, 2a of the inner member 3. A cylindrical securing portion 25a, formed by turning, is on the outer-side end, i.e. opposite end, to the knuckle mount end of the outer member 25.

The vibration damping mechanism 14 is secured on the securing portion 25a by press-fitting. The vibration damping mechanism 14 is secured on the securing portion 25a which is stator-side of the bearing. Thus, it is unnecessary to strongly increase the securing force taking bulging of the vibration damping mechanism 14 into consideration. Also, it enables easy and simple assembly adjustment and exchange of the vibration damping mechanism 14.

A wheel bearing apparatus shown in FIG. 6 is a further modification of the previous embodiment (FIG. 1). This modification is different from the embodiment of FIG. 1 only in a securing position of the vibration damping mechanism. Accordingly, the same reference numerals are used to designate the same structural elements of the previously described embodiments. Thus, their detailed description will be omitted.

The wheel bearing apparatus shown in FIG. 6 is a so-called “third generation” type for a driving wheel. It includes an inner member 3 with a wheel hub 1 and an inner ring 2 press-fit on the wheel hub 1. An outer member 5 is mounted on the inner member 3 via the double row rolling elements 4, 4.

A vibration damping mechanism 19′ is secured by press-fitting on the inner circumference 5c of the outer member 5. More particularly, the vibration damping mechanism 19′ is on an axially middle position between the outer raceway surfaces 5a, 5a of the outer member 5. This vibration damping mechanism 19′ is different from the vibration damping mechanism 19 of FIG. 3 only in an arrangement of a metal core 21′. Accordingly, the same reference numerals are used to designate the same structural elements of the vibration damping mechanism 19 of FIG. 3. Thus, their detailed description will be omitted.

This vibration damping mechanism 19′ includes the annular weight 15 and the elastic member 20. The elastic member is formed from synthetic rubber, such as NBR etc., and has a predetermined thickness to cover the outer surface of the weight 15. A metal core 21′ is insert molded integrally with the elastic member 20. The metal core 21′ is adapted to be press-fit onto the inner circumference 5c of the outer member 5.

The vibration damping mechanism 19′ is secured on the inner circumference 5c, between the outer raceway surfaces 5a, 5a of the outer member 5, forming the stator-side of the bearing. Thus, it is unnecessary to strongly increase the securing force taking bulging of the vibration damping mechanism 19′ into consideration. This enables simplify the assembling work of the vibration damping mechanism 19′. Further it reduces the amount of grease confined in the bearing to improve the lubrication efficiency while suppressing the stay of grease in the middle of the bearing.

The present disclosure can be applied to a wheel bearing apparatus with an outer member and wheel hub. The outer member has an integrally formed body mounting flange. The wheel hub has, at its one end, an integrally formed wheel mounting flange. A relatively large axial pitch distance is present between double row rolling elements.

The present disclosure has been described with reference to the preferred embodiments. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

What is claimed is:

1. A wheel bearing apparatus comprising:
an outer member with an inner circumference and an outer circumference, the outer member inner circumference has double row outer raceway surfaces, the outer member outer circumference is adapted to be mounted on a knuckle of a vehicle;
an inner member with a wheel hub and at least one inner ring, the wheel hub is integrally formed, on its one end, with a wheel mounting flange, a cylindrical portion axially extends from the wheel mounting flange, the inner ring is press fit onto the cylindrical portion of the wheel hub, an outer circumference of the inner member has double row inner raceway surfaces that oppose the double row outer raceway surfaces;
double row rolling elements are contained between the outer raceway surfaces and inner raceway surfaces, respectively, of the outer member and the inner member; and
a vibration damping mechanism is mounted on a portion of the outer member or the inner member except at portions engaging with their mating components, the vibration damping mechanism prevents resonance vibration between the bearing and its peripheral components.

2. The wheel bearing apparatus of claim 1, wherein the vibration damping mechanism includes a metallic weight and an elastic member covering the outer surfaces of the metallic weight, mounting portions are formed on both ends of the elastic member, annular grooves are formed on outer circumferences of the mounting portions, the vibration damping mechanism is adapted to be secured on the inner member or the outer member by metallic fastening bands to be mounted in the annular grooves.

3. The wheel bearing apparatus of claim 1, wherein the vibration damping member has a metal core insert molded into engaging surfaces of the elastic member, the vibration damping member is adapted to be press-fit on the inner member or outer member via the metal core.

4. The wheel bearing apparatus of claim 1, wherein the vibration damping mechanism is secured on an axially center portion between the double row inner raceway surfaces.

5. The wheel bearing apparatus of claim 1, wherein the inner ring is formed with a cylindrical securing portion extending from the inner raceway surface toward the inner-side via a seal-fitting portion and the vibration damping mechanism is secured on the outer circumference of the securing portion.

6. The wheel bearing apparatus of claim 1, wherein the outer member is formed on its outer-side end with a cylindrical securing portion and the vibration damping mechanism is secured on the securing portion.

7. The wheel bearing apparatus of claim 1, wherein the vibration damping mechanism is secured on the outer member inner circumference between the outer raceway surfaces.
